(19) United States
(12) Patent Application Publication
(10) Pub. No.: US 2026/0213027 A1
(43) Pub. Date: Jul. 23, 2026

(54) HAMR PEBBLE REACTOR

(71) Applicant: Odin Electric, Inc., Centreville, MD (US)

(72) Inventor: Paul Mouring, Centreville, MD (US)

(21) Appl. No.: 19/425,009

(22) Filed: Dec. 18, 2025

Related U.S. Application Data
(60) Provisional application No. 63/736,233, filed on Dec. 19, 2024.

(51) Int. Cl. G21C 1/07; G21C 7/107; G21C 7/36; G21C 19/20

(52) U.S. Cl. CPC G21C 1/07; G21C 7/107; G21C 7/36; G21C 19/202

(57) ABSTRACT

This invention concerns a self-contained nuclear fission reactor which utilizes nuclear fuel to generate thermal energy. The core contains heat pipes rather than a coolant loop to transfer the thermal energy generated, thus allowing the overall size of the reactor to be quite small and to function independently for up to ten years. A TRISO pebble fuel delivery system at the top of the core is connected to a reserve fuel tank such that fuel may be delivered into the core without human intervention. The TRISO fuel sits around the heat pipes. The heat exchanger is suspended above the core and is connected to the heat pipes containing a gaseous substance which conducts the heat generated in the core to the heat exchanger, which is used to power an electrical generator. All the components described are encased in a concrete containment vessel to prevent radiation from escaping the reactor unit.

### CROSS-REFERENCE TO RELATED APPLICATIONS

U.S. Provisional Ser. No. 63/736,233 filed on Dec. 19, 2024

### PRIOR ART

United States Patent Application Publication No. US 2024/0331886 A1 filed on Jun. 5, 2024
U.S. Pat. No. 11,495,363 B2 filed on May 1, 2020
United States Patent Application Publication No. US 2022/0148744 A1 filed on Nov. 9, 2021
United Kingdom Patent Application GB 2628907 A filed on Mar. 8, 2024
United States Patent Application Publication No. US 2022/0139582 A1 filed on Oct. 29, 2020
United States Patent Application Publication No. US 2023/0107838 A1 filed on Feb. 24, 2021
U.S. Pat. No. 10,559,389 B2 filed Feb. 6, 2017
China Patent Registration No. CN111081391B
Laturkar et al., “Advances in Very Small Modular Nuclear Reactors”, CEP Magazine, Apr. 8, 2025, 21 pages.
Lu, C., Kardoulaki, E., Stauff, N. E., & Cuadra, A. (2024), “The Use of High-Density UN Fuel in Heat-Pipe Microreactors”, Nuclear Technology, 211(4), 690-707.
Snow, et al., “Preliminary studies on diversion and misuse for TRISO-fueled heat-pipe-cooled microreactors” Annals of Nuclear Energy, 217(2025 ) 111309

### BACKGROUND OF THE INVENTION

A nuclear fission reactor is an apparatus that utilizes the fission of the nucleus of an atom to produce thermal energy, which is in turn used to create electrical energy, a process well known in the art. Traditional nuclear fission reactors use uranium as their primary fuel source. This can either take the form of pure elemental uranium or a compound of uranium and other elements which can form a ceramic-like fuel “pebble” or “pellet.” The fuel is housed in the reactor core which also houses other components that are necessary for energy production. Some reactor designs utilize TRISO fuel, a type of ceramic fuel compound. TRISO fuel was developed in the 1960's for the Dragon reactor, an experimental, high temperature, gas-cooled reactor engineered in the United Kingdom. TRISO fuel also saw use in West Germany starting in the 1970's. It is a robust, meltdown-resistant fuel, which can withstand extremely high temperatures without cracking, which helps prevent a nuclear meltdown scenario.

In traditional reactor design, the thermal energy produced by the atomic chain reaction in the reactor core is conducted via a medium in the core, such as pressurized water, which is referred to as “coolant.” The coolant conducts the thermal energy to a “coolant loop,” a set of coiled tubes, which pass through the coolant in reactor core. The coolant loop exits the reactor core and then passes through a steam generator. The coolant loop carries the thermal energy out of the core to the steam generator, heating a conductive medium in the steam generator. This thermal energy in the steam generator medium is then picked up by a secondary coolant loop containing water. The secondary coolant loop, after passing through the steam generator, carries the thermal energy in the form of steam out of the steam generator and into a turbine and electrical generator, thus creating electricity. After the coolant leaves the turbine, it may go through a condensing cycle to remove any excess heat, and subsequently back into the steam generator to repeat the cycle. Control rods, which are comprised of a metal that absorbs neutrons, are introduced to the core to varying degrees in order to slow the number of atomic chain reactions taking place and thus control the amount of thermal energy created by the core at any given time.

It is known in the art that the components which are necessary for the construction of a successful, traditional nuclear reactor are nuclear fuel, the reactor core containing coolant, two coolant loops that conduct thermal energy and which transfer heat energy to the rest of the system, control rods to regulate the amount of thermal energy produced, a control apparatus, a turbine and an electrical generator. Additionally, the reactor could have a neutron moderator, heat exchangers, condensers, compressors, and fuel tanks. As a result of the need for two coolant loops, traditional reactor design results in very large nuclear reactor structures.

Traditional nuclear reactor construction takes place on-site at a powerplant, which is always a very large tract of land where the reactor will be used to supply electricity to a municipality. It is therefore advantageous to construct a traditional nuclear reactor on a site which has already been granted regulatory approval and to design and build the largest power plant that can be built on that site. There is always a fear that a nuclear reactor could have an accident leading to a nuclear meltdown, so for safety reasons the locations for nuclear power plant sites are limited to areas distant from large population centers. Construction times are long and, once a nuclear plant is built, the land on which it resides will be unusable for other purposes, even many years after a plant is shut down. The location and size of traditional nuclear power plants are therefore limiting factors which inhibit the achievement of economies of scale in the production of nuclear energy.

There is a need for a nuclear reactor design that lends itself to better economies of scale in order to enable the production of cheaper energy. This is one of the largest challenges the nuclear energy industry has faced since its inception. The purpose of the present invention is to produce nuclear energy in a cheaper, more accessible way. Through the mass production of smaller nuclear reactors designed as described herein which can be installed in many different environments (commercial buildings, residential housing, industrial sites, etc.), the present invention will achieve this goal.

### SUMMARY OF THE INVENTION

The present invention relates to smaller, modular, high-temperature nuclear fission reactors and related components, systems and methods and is an improvement upon the utility of traditional nuclear reactors. The use of a simplified cooling system, in this case heat pipes, instead of one of the two large cooling loops, results in a simpler overall reactor design. Heat pipes will take up significantly less space in the reactor than a traditional coolant loop, and will provide for a more efficient transfer of thermal energy to a heat exchanger unit. The reactor is located within a concrete containment vessel with the related components necessary to generate electricity including, but not limited to, a heat exchanger and electrical generator, and with enough fuel to run untended for ten years. This simplified reactor structure results in a significantly smaller overall reactor footprint and thus a more versatile reactor for the production of cheap energy.

It is also an object of the present invention to take advantage of the structural properties of Tri-structural ISOtropic particle fuel, more colloquially known as TRISO fuel. The use of TRISO fuel in combination with the unique use of heat pipes, allows the construction of a simpler nuclear reactor with fewer parts, fewer failure points, much reduced in size, increased in efficiency and requiring fewer man hours to construct. The structure of TRISO fuel allows it to achieve higher temperatures without melting down, thus increasing the thermal output of the reactor without requiring increased size.

As TRISO fuel gets hotter, it produces fewer neutrons than it would at lower temperatures and TRISO fuel has the ability to trap daughter-products of the fission reaction, which gives it the ability to resist a nuclear meltdown and eliminates the need for more complex safety equipment. The partnering of the TRISO fuel pebbles with the heat pipes for the thermodynamic conduction system is conducive to the goal of an ultra-compact and sustainable nuclear reactor because the reactor will require fewer parts, require fewer man-hours in the manufacturing process, lessen the number of failure points, reduce the overall size and footprint and increase the efficiency of the reactor design. The reactor components are configured in a manner that allows for energy generation in a way conducive to the goal of this invention, making nuclear energy cheaper to produce.

Ultimately, the design of the core and thermodynamic system of the present invention allows for a compact and self-regulating apparatus. Such a reactor does not need to occupy a large tract of land and does not need to be located far away from human populations but could rather be installed anywhere. This invention could be produced to power all sorts of different power demands and could deploy in any location all over the world because the design is inherently safe. The fact that this nuclear reactor does not require the additional containment and safety structures that other reactors do leads to a less bulky, lighter weight, more simplistic construction resulting in the generation of cheaper nuclear energy.

### BRIEF DESCRIPTION OF DRAWINGS

Non-limiting and non-exhaustive examples are described with reference to the following Figures.

FIG. 1 depicts an isometric view of the containment vessel of the nuclear reactor including the components contained therein, exempting the heat pipes.

FIG. 2 depicts a cross-sectional view of the containment vessel of the nuclear reactor including the components contained therein, exempting the heat pipes.

FIG. 3 is a cross-sectional view of some of the nuclear reactor components including the core and the heat exchanger connected to each other via the heat pipes, as well as the reserve fuel tank and its connection to the core.

FIG. 4 is a cross-sectional view of the core of the nuclear reactor with the heat pipes and nuclear fuel shown.

### DETAILED DESCRIPTION OF THE INVENTION

Herein follows an overall understanding of the principles of the structure, function, manufacture and use of the systems, methods and devices comprising the invention. The terms as used in the disclosure are provided to merely describe specific embodiments and are not intended to limit the scope of other embodiments. Singular forms include plural referents unless the context clearly dictates otherwise. The terms and words as used herein, including technical or scientific terms, may have the same meanings as those generally understood by those skilled in the art. The terms, as generally defined in dictionaries, may be interpreted as having the same or similar meanings as or to the contextual meanings of the relevant art. Unless otherwise defined, the terms should not be interpreted as ideally or excessively formal meanings. Even though a term is defined in the disclosure, the term should not be interpreted as excluding embodiments of the disclosure under any circumstances. The disclosure and the terms used therein are not intended to limit the technological features set forth herein to particular embodiments and include various changes, equivalents, or replacements for a corresponding embodiment. With regard to the description of the drawings, similar reference numerals may be used to refer to similar or related elements. It is to be understood that a singular form of a noun corresponding to an item may include one or more of the things, unless the relevant context clearly indicates otherwise. As used herein, each of such phrases as “A or B”, “at least one of A and B”, “at least one of A or B”, “A, B, or C”, “at least one of A, B, and C”, and “at least one of A, B, or C”, may include any one of, or all possible combinations of the items enumerated together in a corresponding one of the phrases.

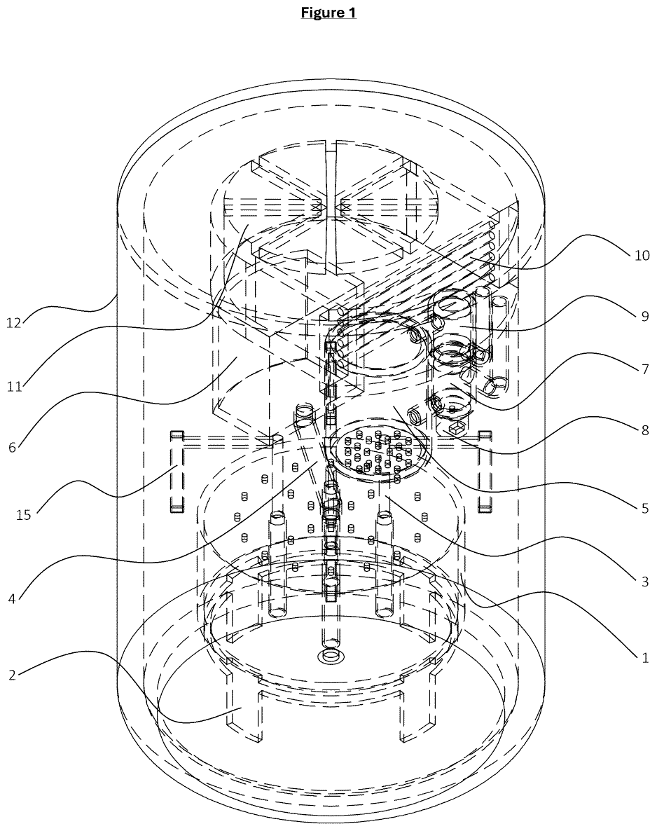

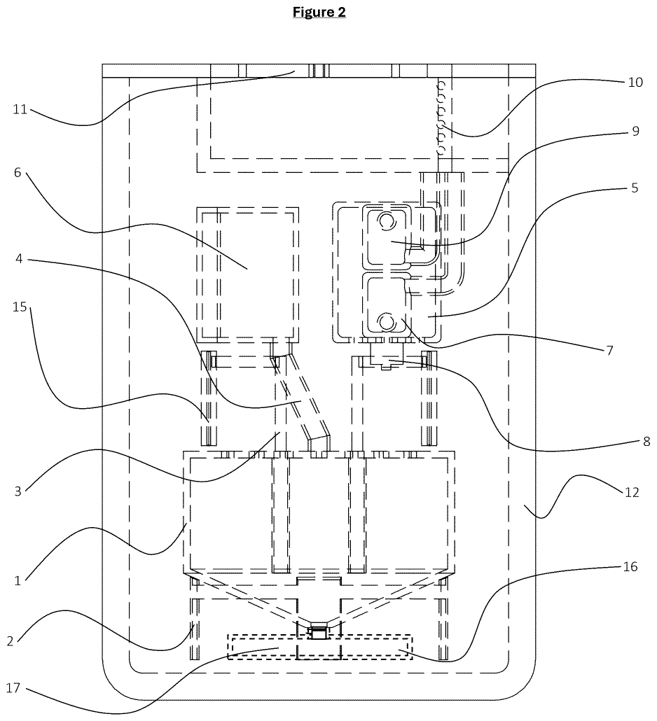

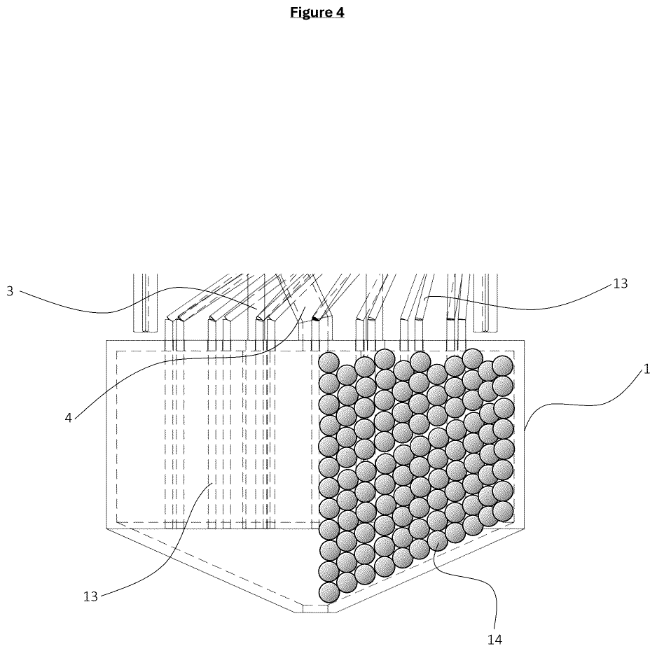

The present invention is an improvement upon traditional nuclear reactor design resulting in a safer, smaller, less complex nuclear reactor that does not require a large, remote, regulated tract of land on which to operate. The objectives of the present invention are attained by utilizing a cylindrical steel core 1 structure, as shown in FIGS. 1, 2, 3 and 4. The TRISO nuclear fuel 14 used in the core can come in two final forms, pellets and pebbles. The preferred embodiment of the present invention relates to the latter. The TRISO fuel pebbles 14 occupy the core 1, as shown in FIG. 4, and they surround a cluster of heat pipes 13 which could, but don't have to, extend to the bottom of the funnel-shaped core 1, which are variable in number and spaced evenly around the core 1 in a circular pattern or possibly several concentric patterns. The proximity of the pebbles 14 to the heat pipes 13 allows for the efficient conduction of thermal energy from the pebbles 14 to the heat pipes 13. The core 1 is otherwise filled with an unpressurized gas which serves as a secondary medium for conveying the thermal energy generated by the TRISO fuel pebbles 14 to the heat pipes 13, the first being conduction from the pellets which are in direct contact with the heat pipes 13. The top of the core 1 has openings such that control rods 3 and heat pipes 13 may penetrate into the core 1. The vertically-oriented control rods 3 which penetrate the core 1 are connected to actuators and motors 15, well known in the art, which provide the ability to alternately retract them from the core 1 and to plunge them back in, thus controlling the rate of the nuclear chain reaction and the amount of thermal energy produced. By means that are well known in the industry, the control rods 3 are either sealed to the top of the core 1 or are encased in a sheath outside the core to prevent the escape of nuclear fission byproducts, as is well known in the art.

TRISO fuel pebbles 14 are constructed with multiple layers of elements or compounds that not only start and sustain the fission reaction, but which also trap radioactive daughter products (elements that occur after the fission of the uranium atom) within the fuel pebble. This adds a layer of safety to the design because they can withstand much greater temperatures than other nuclear fuels, reducing the possibility of a nuclear meltdown and thus eliminating the need for a thicker reactor core 1 wall structure and additional safety structures in the core 1 which add bulkiness, weight, and construction complexity. The TRISO fuel pebbles 14 have the secondary advantageous properties of anti-corrosion and anti-oxidation which both serve to prolong the reactor core 1 structure service life.

The TRISO fuel pebbles 14 may be added, as needed, to the core 1 via a pipe 4 connected to the top of the core 1 which runs to a reserve fuel tank 6 made of steel and suspended above the core 1. Various fuel tank designs, well known in the art, such as a taller and narrower cylinder design that will stop nuclear reactions and/or neutron-absorbent material installed on the tank walls, enable the tank to store the pebbles 14 without causing a nuclear reaction. The top of the core 1 may either be flat or curved. Once introduced to the core 1, the fuel pebbles 14 drop into the funnel-shaped bottom of the core 1 and come to rest against the heat pipes 13, surrounding them in a manner conducive to the conduction of thermal energy, as shown in FIG. 4. Because new pebbles 14 are introduced to the core 1 at the top, over time fuel pebbles 14 that are depleted will reside at the bottom of the core 1. Depleted TRISO fuel pebbles 14 at the bottom of the core 1 are removed by the periodic opening of a sliding panel or other removal device well known in the art. Pebbles 14 which fall through the panel, or which are removed by some other pebble-removal device, are conveyed to a spent fuel tank 16 situated below the core 1 via a pipe 17 connected to the bottom of the core 1. The funnel-shaped core 1 bottom guides the pebbles to the mouth of the pipe 17. To effect the addition and removal of the fuel pebbles 14, controlled actuators could be used to introduce or remove one fuel pebble 14 at a time at both the top and bottom of the reactor core 1, respectively. The pipes 17 through which the fuel pebbles 14 are added to, and removed from, the core 1 have a diameter larger than the diameter of the fuel pebbles 14 so that the fuel pebbles 14 may easily pass through them.

Actuators and motors 15 are used to control the vertical movement of each control rod 3 so as to provide for variable penetration into the core 1. Heat sensors (and other types of sensors), variably located inside or outside the core 1, provide feedback to the actuators and motors 15 so as to position the control rods 3 optimally, which provides a great degree of control over the rate of the nuclear chain reaction and thus the amount of thermal energy produced. The number of control rods 3 in the reactor design is not fixed and more may be added if the size of the reactor is such that more control over the chain reaction is necessary. In the event the nuclear reaction gets out of control, which could lead to a nuclear meltdown, safety features well known in the art will be part of this reactor design, such as an electromagnet release which plunges the control rods 3 into the core 1 to slow the nuclear reaction.

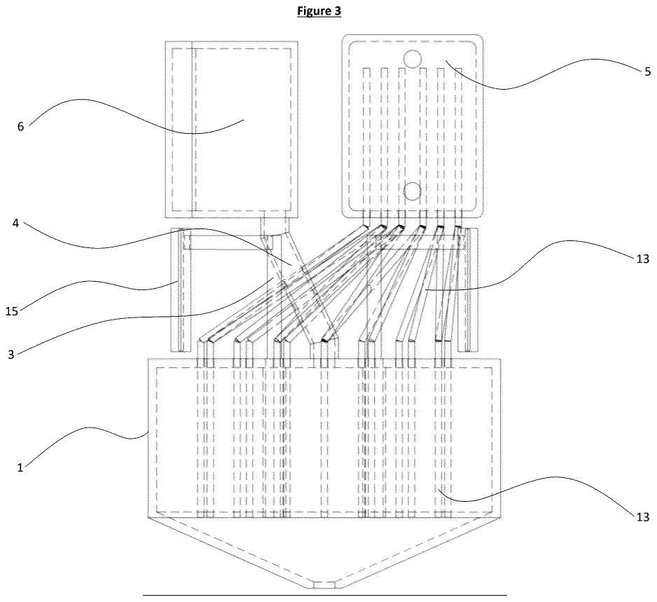

The present invention employs a system which extracts the heat generated in the core 1 and carries it away. The system is comprised of a variable number of regularly situated heat pipes 13, penetrating the top of the core 1. These heat pipes 13 are made of copper, are hollow in the center and are capped with copper at both ends. Inside the hollow center, there is either a liquid or gaseous substance conducive to the conduction of thermal energy. The heat pipes 13 have excellent thermal conductivity, leading to an efficient heat transfer process from the core 1 to a heat exchanger 5 suspended above the core 1. The number of heat pipes 13 in the reactor design depends upon the desired energy output of the reactor. The heat pipes 13 protrude from the top of the core 1 and meet and extend into the body of the heat exchanger 5, as shown in FIG. 3. The insertion pattern for the heat pipes 13 on the heat exchanger 5 may not line up with their insertion pattern on the core 1 because the profile and size of the core 1 and the heat exchanger 5 may be different, therefore the fabrication of the heat pipes 13 may require different bends and lengths, according to the geometry needed to achieve the desired connection.

The heat pipes 13 will partially penetrate the core 1 from the top in a uniform, circular pattern. Multiple concentric circles of heat pipes 13 may be used if additional conductive capacity is needed. The heat pipes 13 enhance the performance of the reactor by allowing an extremely efficient heat transfer process to occur with fewer reactor components required. The TRISO fuel pebbles 14 are tightly packed around the heat pipes 13 within the core 1 whenever the fuel pebbles 14 are sedentary (not moving in and out of the core 1) as shown in FIG. 4. The heat pipes 13 occupy a set space within the core 1 while the fuel pebbles 14 occupy the space around the heat pipes 13. The primary mode of heat transfer from the pebbles 14 to the heat pipes 13 is conduction, with convection and radiation through the gaseous substance in the core 1 occurring as a secondary transfer means.

The use of the heat pipes 13 in the thermodynamic system of the present invention with the fuel pebbles 14 is a simplification and improvement of the traditional nuclear reactor cooling design. A traditional cooling system consists of two loops of coolant flow, one through the reactor core and heat exchanger and one through the heat exchanger and turbine. The heat pipes 13 used in the present invention are more compact and they eliminate the need for two coolant loops, as they connect both the core and the heat exchanger 5 with no need to circle back. Also, the heat pipes 13 do not need a pump to perform their task, unlike a traditional coolant loop. The elimination of a pump simplifies the reactor design and reduces the cost of constructing the nuclear reactor. Another added benefit of using heat pipes 13 is the increase in heat transfer efficiency, improving the performance of the nuclear reactor and reducing the total amount of fuel needed to reach the desired power output.

The present invention employes a heat exchanger 5, of variable design well known in the art, to remove thermal energy conducted by the heat pipes 13 and to ultimately deposit that thermal energy in a turbine 7. The heat exchanger 5 may be comprised of a housing with internal structures constructed of a single metal or multiple metals. The thermal energy from heat pipes 13 is transferred to the internal structures of the heat exchanger 5 ideally via conduction. The heat exchanger 5 may also contain a separate conductive medium, which can be either liquid or gas, which is contained in what would be the secondary coolant loop in a traditional reactor design, but which is the only coolant loop in the present design. The liquid or gas medium in this coolant loop is pumped through the heat exchanger 5 by a compressor 9 which may be powered by a shaft from the turbine 7. The heat exchanger 5 ideally has an internal fan proximally located to the heat exchanger 5. The conductive medium enters the heat exchanger 5 through an opening on one side and passes over the internal structures of the heat exchanger 5 absorbing thermal energy as it flows through, ultimately exiting through an outlet. After leaving the heat exchanger 5, the conductive medium with the absorbed thermal energy enters a turbine 7.

The turbine 7, of variable design well known in the industry, of roughly cylindrical shape, is also suspended above the core 1, proximally located to the heat exchanger 5 and below the compressor 9. The turbine's 7 internal components may be comprised of a fan structure with blades connected to a shaft at the center axis of the turbine 7. The shaft extends out of the turbine 7. The purpose of the turbine 7 is to convert the thermal energy from the heat exchanger 5 into rotational energy. The conductive medium from the heat exchanger 5, either in liquid or gas form, passes into the turbine 7 through a pipe connected to the heat exchanger 5 and then passes over the blades of the fan, causing the shaft to which the fan blades are attached to rotate. The conductive medium is finally expelled out the other end of the turbine 7. The conductive medium, having shed its thermal energy, is then conveyed back to the heat exchanger 5 by another pipe where it will pick up more thermal energy, continuing the cycle. The rotational action of the turbine 7 shaft, which extends into the electrical generator 8 which creates electricity.

If the medium passing out of the turbine 7 contains excess heat, that heat may be shed from the medium by the condenser 10, of variable design well known in the art, sitting in-line between the turbine 7 and the return line to the heat exchanger 5. The condenser 10 may consist of a structure of pipes and metal fins configured in a uniform manner and may have a fan 11 which blows a gas, preferably oxygen, over the condenser 10 pipes. The condenser 10 has an inlet and an outlet so that the medium may be conducted through the fins. The conductive medium enters the inlet, radiates excess heat away from the condenser 10, and exits through the outlet.

All of the foregoing reactor components are encased in a larger structure made out of concrete which is known in the art as a containment vessel 12. The core 1 is supported within the containment vessel 12 by metal feet, or core supports 2, as shown in FIG. 1, for structural integrity. The purpose of this containment vessel 12 is to hold and contain the reactor components and to shield the outside from harmful radiation. The electricity created by the turbine 7 is conducted by wiring which passes through the containment vessel 12 and which may be connected to a power grid of any size.

In another embodiment of the present invention, a powered fan 11 is present in the system with an inlet leading from the exterior of the containment vessel 12 to the condenser 10 from the previous embodiment, and outlet leading to the exterior of the containment vessel 12. The primary purpose of this part of this subsystem is to expel excess heat from the containment vessel 12. This subsystem drives air from outside the containment vessel 12, passes it over the condenser 10, and finally expels it from the containment vessel 12, thus expelling excess thermal energy without expelling harmful radiation to the atmosphere.

1. A nuclear fission reactor system, comprising:
a cylindrical steel nuclear reactor core with a funnel-shaped bottom supported within a containment vessel and configured to receive Tri-structural ISOtropic particle fuel pebbles for the generation of thermal energy through nuclear fission;
a plurality of copper heat pipes disposed within the core and arranged in a uniform, circular pattern, each heat pipe containing a liquid or gaseous conductive medium for transferring thermal energy from the core to a heat exchanger positioned external to the core;
a plurality of TRISO fuel pebbles packed around the heat pipes to maximize thermal conduction
a plurality of control rods composed of a neutron-absorbing metal alloy, movably inserted into the core through openings at the top of the core by motors and actuators driven by sensors within the core to regulate the nuclear fission reaction;
sensors positioned within or proximate to the core, configured to monitor the nuclear fission reaction and provide feedback to the actuators and motors for precise control rod positioning;
a gaseous heat transfer medium within the core configured to facilitate thermal energy transfer from the TRISO fuel pebbles to the heat pipes via convection;
an automated fuel delivery system comprising a steel reserve fuel tank including neutron-absorbing material on its walls to prevent unintended nuclear reactions connected to the core via piping, configured to deliver TRISO fuel pebbles into the core without human intervention;
an automated spent fuel removal system comprising a sliding panel at the funnel-shaped bottom of the core, configured to release spent TRISO fuel pebbles through a pipe and into a spent fuel tank positioned below the core;
a heat exchanger suspended above the core, and attached to the heat pipes, comprised of internal structures made of one or more metals and incorporating a conductive medium, either liquid or gas, pumped through the heat exchanger by a compressor and configured to transfer thermal energy to a turbine;
a turbine operatively coupled to and powered by the heat exchanger, configured to convert thermal energy into rotational energy;
an electrical generator coupled to the turbine, configured to convert rotational energy into electrical energy;
a condenser sitting in-line between the turbine and the return line to the heat exchanger configured to remove excess heat from the conductive medium exiting the turbine; and the fan proximate to the condenser, configured to blow a gas over the condenser to facilitate heat dissipation
a concrete containment vessel configured to prevent radiation leakage encasing the core, heat exchanger, turbine, electrical generator and
wiring passing through the concrete containment vessel configured to conduct electricity from the electrical generator to an external power grid.

2. The nuclear reactor of claim 1, whereby the condenser incorporates a fan which blows a conductive medium over its pipes.

3. The nuclear reactor of claim 1, further comprising a powered fan system with an inlet and outlet connected to the exterior of the containment vessel, configured to expel excess heat from the condenser to the external environment without releasing radiation.

4. The nuclear reactor of claim 3, whereby the condenser incorporates a fan which blows a conductive medium over its pipes.
